(19) United States
(12) Patent Application Publication
(10) Pub. No.: US 2001/0012792 A1
(43) Pub. Date: Aug. 9, 2001

(54) AUTOMATICALLY ADJUSTING ACOUSTIC OUTPUT OF THE SPEAKER OF A TELEPHONE HANDSET

(76) Inventor: MATTHEW J. MURRAY, RALEIGH, NC (US)

Correspondence Address: BRINKS HOFER GILSON & LIONE, P.O. BOX 10395, CHICAGO, IL, 60610, US

(21) Appl. No.: 09/321,477

(22) Filed: May 27, 1999

(51) Int. Cl. H04M 1/00; H04B 1/38; H04R 29/00

(52) U.S. Cl. 455/567; 381/56

(57) ABSTRACT

An apparatus and system automatically adjusts the acoustic output of a wireless handset. The system includes an actuator, a piezoelectric disk and a controller. The actuator generates vibrations that produce sound. The piezoelectric disk detects the acoustic vibrations of the actuator and the associated loudness of the sound. The controller analyzes the detected sound and, if necessary, adjusts the actuator or an input amplifier of the actuator to produce a desired acoustic output.

### BACKGROUND OF THE INVENTION

1. Technical Field of the Invention

The present invention relates to a system and apparatus for controlling the sound output level of the speaker and/or buzzer in the handset of a telephone and, more particularly, for the handset of a wireless communication device.

2. Description of the Related Art

Wireless devices commonly use actuators and diaphragms to translate electrical signals to the sounds of speech. A buzzer may be added to provide an audible alarm. Alternatively, in some devices, the actuator and diaphragm provide both speech and a buzzer alarm. The actuator, diaphragm and buzzer, if available, are typically positioned in the receiver portion of the handset of a wireless device in order to allow sound to pass to a user's ear. The volume level of the actuator may be manually adjusted to amplify the sound, for example of speech or of a ringing or buzzing alert, and to reduce the sound when the receiver is pressed against the ear.

In normal use of a wireless handset, it is possible that a user could have the receiver of the handset pressed against his ear at the time that a loud alert sound is generated. In this case, the actuator and diaphragm are capable of generating sound at an excessive volume that could cause a user to suffer substantial pain or even a loss of hearing. Attempts to reduce or limit volume levels to avoid this condition could result in missed phone calls or poor audio quality, especially when a receiver is in a remote location, is used in a noisy environment, or is concealed, for example in a purse.

A system is known to provide some automatic volume control in the wireless art by using infrared sensors to detect the proximity of a receiver to a user's ear when the wireless device is in a buzzer alert mode. The system may either reduce the volume in such a case or employ a series of tones that steadily increase in volume to warn a user to move the phone away from his

FIG. 3 is a partial cross-sectional view and block diagram of another embodiment of a receiver portion of a handset of the invention.

FIG. 4 is a partial cross-sectional view and block diagram of another embodiment of a receiver portion of a handset of the invention.

### DETAILED DESCRIPTION OF THE PREFERRED EMBODIMENTS

In the drawings, elements are not necessarily drawn to scale, and the same reference numbers through several views designate the same or similar elements. FIG. 1 illustrates a partial cross-sectional view and block diagram of the receiver portion 1 of a prior art telephone handset which has sound apertures 3 and encloses an actuator 5. The actuator 5 may be of the tri-mode variety which operates in three different modes in order to reproduce speech, a buzzing alarm and silent vibrations. A tri-mode actuator is commercially available from Tokin America, Inc. of San Jose, Calif. As shown in FIG. 1, an antenna 7 receives radio signals for speech and these signals are demodulated by a demodulator 8 and converted to analog actuation signals by a codec 9. The signals are then amplified by an amplifier 10 and the amplified actuation signals are applied to an actuator module 13. The module electromagnetically produces vibrations that are coupled to a plastic diaphragm disk 15 which produces sound that passes through the apertures 3 to the ear 4 of the user. As used hereinafter, the term “actuator” is used to refer to an electromechanical transducer that energizes a coil of wire and converts electrical signals to magnetic fluctuations which vibrate a mechanical element that produces sound.

The diaphragm disk 15 is supported in spaced relation to the plastic wall 17 of the receiver by a ring of commercially available resilient acoustic speaker tape 19 that has a sticky adhesive on its top and bottom surfaces. The ring of tape 19, shown in cross-section in FIG. 1, therefore adheres to the inside surface of the receiver and a circular ridge 21 formed in the diaphragm disk 15. The air space between the disk 15 and inside wall 17 of the receiver defines an acoustic chamber 18 that acoustically couples the diaphragm to the user's ear.

A ring of double-sided speaker tape 23 is disposed between and adhered to the actuator module 13 and the top of the diaphragm disk 15. The tape forms an air gap that defines an acoustic chamber 20 and acoustically couples the actuator module 13 to the diaphragm disk 15. The tape rings 19 and 23 therefore act as acoustic gaskets that contain volumes of vibrating air that determine, in part, the sound produced by the actuator. The defined air chambers may enclose a volume of, for example, about one hundred and thirty cubic millimeters of air. However, the total air volume can vary and is adjusted to accommodate the aperture 3 sizes and the back volume of air enclosed by the handset.

The known handset of FIG. 1 can apply a painfully high volume sound to a user's ear, for example if the handset is held against the ear when a loud alarm sound such as a “buzz” is generated by the actuator module 13 and its associated diaphragm 15 under the control of a microprocessor 14. This painful and dangerous condition can be avoided by actively monitoring and controlling the magnitude of sound that is generated as the receiver approaches and is acoustically sealed to the ear. FIG. 2 illustrates an embodiment of a telephone handset that has been modified to provide this acoustic safety feature.

As shown in FIG. 2, a piezoelectric film 25 in the shape of a disc is adhered to the diaphragm 15, for example by an adhesive. As an example, the piezoelectric film may be 0.5 mm thick and about 25 mm in diameter and the diaphragm may be about 1.5 mm thick and about 30 mm in diameter. The piezoelectric disk is commercially available and is manufactured by AMP, Inc. of Harrisburg, Pa. A Tokin 15 mm model 3MA multiactor is preferred for use as a tri-mode actuator for the disk 25 and diaphragm 15, although other actuators could be used.

As the diaphragm 15 vibrates in response to the vibrations of the actuator module 13, the piezoelectric disk 25 also vibrates and generates analog electrical signals that are proportional to the magnitude of the vibrations that create sound. The piezoelectric disk 25 therefore operates as a transducer or sound sensor that generates signals corresponding to the magnitude of the sound that is produced by the actuator and diaphragm speaker elements of the handset.

The piezoelectric disk 25 is connected to an analog-to-digital (A/D) converter 26 by electrodes 28 that are connected on opposite surfaces of the disk. The analog signals of the piezoelectric disk 25 are converted to digital signals by the A/D converter 26. These digital signals are applied to a controller 29 that includes a microprocessor.

The controller 29 compares the amplitude of the sensed vibrations to a predetermined maximum safe amplitude. As an example, a recognized safe level of sound may be about 120 dbspl peak (as opposed to rms sound pressure level). If the detected sound exceeds this level, the controller 29 reduces the amplification of the amplifier 10 by applying control signals through a digital-to-analog (D/A) converter 30 and therefore reduces the level of sound produced by the actuator module 13 and diaphragm 15 to a predefined acceptable level, for example 120 dbspl, or within a range of acceptable levels. The disc 25, A/D converter (26), D/A converter (30), and controller 29 therefore comprise a feedback loop that adjusts the level of sound of the actuator.

Persons of ordinary skill in the acoustic arts will understand that the acoustic volume to which the speaker elements of the handset 1 are exposed, is considered infinite when the handset is disposed in open air with no sealing obstruction against the apertures 3 and diaphragm 15. This exposure to an infinite acoustic volume applies a large acoustic load to the actuator's diaphragm and makes its operation very inefficient. This loading of the diaphragm limits its total displacement and thus its loudness. When the receiver is sealed against the ear 4, the acoustic volume is considerably reduced and displacement of the vibrating diaphragm 15 and piezoelectric disk 25 is therefore greater for a given level of actuating energy. Thus, the loudness of a ringing or buzzing sound, for example, may be acceptable when the receiver is subjected to an infinite volume in open air, but it may be unacceptable when the receiver is coupled to the ear under a substantially reduced acoustic load. The piezoelectric system of the invention therefore ear. The inclusion of this system in wireless devices requires additional system space in a technology striving for smaller compact designs. The proximity sensor could also unnecessarily reduce acoustic volume when sealed in a purse or covered with clothing. Also, a user could be injured if the sensor fails or if the receiver is pressed against the ear when the volume of the alarm tone increases to a maximum.

There is therefore a need for a simple and reliable system that automatically reduces the volume of the speaker and/or buzzer of a telephone handset to a safe level when the handset is pressed against the ear and increases the volume as required to hear alarm sounds when the handset is positioned away from the ear. With a growing consumer preference for smaller devices, there is also a need for an acoustic output control that promotes user safety without compromising the functionality, convenience, or the size of wireless devices. These and other features of the invention will become apparent from a review of the following drawings, specification and claims.

### SUMMARY OF THE INVENTION

The apparatus and system of the invention automatically adjusts the acoustic output of a wireless handset. The system comprises an actuator, a piezoelectric disk, and a controller. The piezoelectric disk senses the amplitude of sound vibrations of the actuator and feeds back a corresponding signal to the controller which maintains the sound vibrations of the actuator within a specified safe volume range. The technology used in this system is compatible with existing wireless hardware, and is therefore safe, low-cost and highly flexible.

### BRIEF DESCRIPTION OF THE DRAWINGS

FIG. 1 is a partial cross-sectional view and block diagram of a receiver portion of a prior art handset.

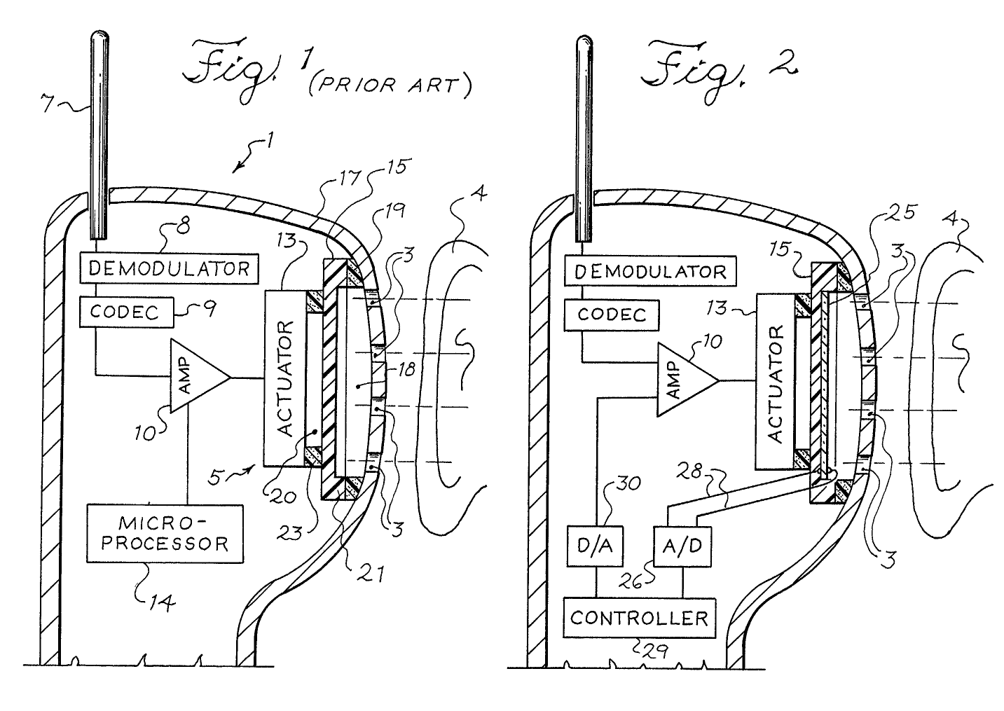

FIG. 2 is a cross-sectional view and block diagram of an embodiment of a receiver portion of a handset of the invention. automatically adjusts sound vibrations to a predefined safe level or range of levels in response to varying acoustic loads that are encountered in normal use of the handset.

In operation of the controller 29, the voltages of the electrical signals generated by the piezoelectric disk 25 are sampled over time and a known fast Fourier transform (fft) is used to translate the voltage time domain signal data into the frequency domain. The amplitudes and associated frequencies for the acoustic signals that are measured are then analyzed. One embodiment could use known table look-up methods with A-weighting information that reports the sensitivity of the human ear to different frequencies of sound. This analysis determines whether an excessive amplitude exists for any given frequency and accounts for the non-linearity of the human ear. The amplification of any excessively loud sound is reduced, for example in a step-wise fashion, to a safe level. The rate at which a sound ramps up to an unacceptable level may also be detected and the amplification of the sound may be reduced to an acceptable level by a corresponding rate of reduction of the amplification.

The operation of the controller and its included microprocessor is determined by executing microprocessor readable code. Preferably, this code is written in assembly language but it may also be written in other higher level languages. The code is stored in a microprocessor readable medium, which may include, for example, magnetic memory, optical memory, and/or electronic memory.

FIG. 3 illustrates an alternative embodiment of the apparatus of the invention wherein the piezoelectric disk 25 serves as both the diaphragm and the vibration transducer. In this embodiment the disk 25 is vibrated by the actuator module 13 to produce sound. The disk 25 also generates electrical signals as previously described to correspond to the loudness of the sound that is produced.

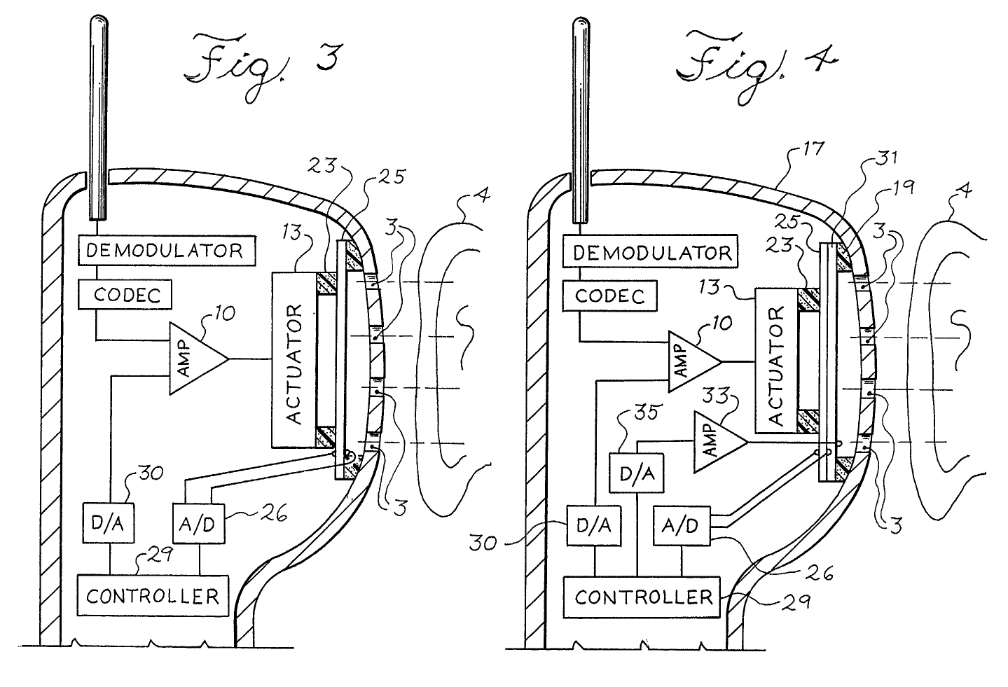

In the embodiments of FIGS. 2 and 3, the piezoelectric disk 25 is used to sense vibrations. As shown in FIG. 4, these embodiments may be enhanced by using a second piezoelectric disk 31 which is adhered to the first disk 25 and which is stiffened by the operation of the controller 29, D/A converter 35 and an amplifier 33 in order to physically limit and/or cancel the output of the actuator module 13. For example, in the vibrator mode, it is desired to produce a vibration that can be felt but not heard. In this mode audible sound could be reduced or eliminated by applying a D.C. voltage from the amplifier 33 to stiffen the piezoelectric disk 31. In this mode the controller 29 could be programmed to provide the DC voltage to the disk by activating the D/A converter 35 and amplifier 33. Alternatively, an AC signal could be applied to the disk 31 exactly out of phase with the vibrations produced by the actuator. The sound from the actuator would therefore be actively cancelled. The piezoelectric disk 31 could also be operated in a similar manner to reduce the volume of sound without requiring an adjustment in the amplifier 10 or actuator module 13.

Variations and modifications of the embodiments disclosed herein may be made without departing from the scope and spirit of the invention. For example, the disclosed acoustic gaskets may be of a type that is adhered by sonic welding rather than an adhesive. Also, although a tri-mode actuator is preferred, other types of actuators, such as single mode actuators could be used. A separate alarm buzzer could be used with such devices. In addition, the sound of the actuator could be controlled by adjusting something other than the gain of the input amplifier. For example, the resistance of an electromagnetic coil in the actuator could be varied to control the volume of sound or a variable resistor could be used, for example as a voltage divider, to adjust the input voltage of the amplifier and thereby control the output level of sound.

It is also within the scope of the invention to increase volume levels. If, for example, the output sound is detected below a predetermined volume level, the controller could direct the actuator or audio amplifier to increase the volume to a desired loudness. The controller could therefore increase and decrease the actuator output in response to varying acoustic loads on the speaker elements in order to maintain a desired volume or to operate within a desired range of acceptable volumes.

Also, the volume control of the invention may be implemented through digital or analog circuitry and may be used for any kind of acoustic device, including landline telephones as well as wireless telecommunication systems, such as cellular, mobile and personal communication systems. The aforementioned description is intended to be illustrative rather than limiting and it should therefore be understood that the following claims and their equivalents set forth the scope of the invention.

What I claim is:

1. A method for controlling the loudness of sound produced by a sonic device, comprising the steps of:
producing audible sounds from said device;
detecting the loudness of said produced sounds; and
automatically adjusting the loudness of the audible sounds to a desired loudness.

2. The method of claim 1, wherein said step of detecting includes the step of sensing the loudness of the audible sounds with a piezoelectric element.

3. The method of claim 1, wherein said step of producing includes the step of using an actuator to produce vibrations including audible sounds.

4. The method of claim 1, wherein said step of producing includes the step of using a trimode actuator to produce vibrations including audible sounds.

5. The method of claim 1, wherein said step of producing includes the step of using an actuator to produce vibrations including audible sounds;
and said step of detecting includes the step of using a piezoelectric element to sense the loudness of the audible sounds that are produced.

6. The method of claim 1, wherein said step of producing includes the steps of using an actuator to produce vibrations and using a diaphragm to convert the vibrations to audible sound; and said step of detecting includes the step of using a piezoelectric element to sense the loudness of the audible sounds produced by the diaphragm.

7. The method of claim 1, wherein said step of producing includes the step of using a piezoelectric element as an actuator to produce vibrations, including audible sounds; and said step of detecting includes the step of using the piezoelectric element to sense the loudness of the audible sounds that are produced.

8. The method of claim 1, wherein said step of automatically adjusting includes the step of using a microprocessor controller to evaluate the loudness of the produced sounds and to increase or decrease the level of the sounds to a desired loudness.

9. The method of claim 1, wherein said step of detecting includes the step of sensing the loudness of the audible sounds with a piezoelectric element; and said step of automatically adjusting includes the step of using a microprocessor controller to evaluate the loudness sensed by the piezoelectric element and to increase or decrease the level of the sounds to a desired loudness.

10. The method of claim 1, including the step of sensing the loudness of the audible sounds with a first piezoelectric element and selectively applying a D.C. signal to stiffen a second piezoelectric element and thereby prevent or reduce audible sounds.

11. The method of claim 1, including the step of sensing the loudness of the audible sounds with a first piezoelectric element and selectively causing a second piezoelectric element to vibrate in a manner which sonically cancels or reduces the audible sounds.

12. A method for controlling the loudness of sounds produced by a telephone handset, comprising the steps of:
receiving transmitted signals corresponding to speech;
converting said signals into corresponding sonic vibrations;
sensing the level of loudness of the audible sound with a piezoelectric element; and
adjusting the loudness of the audible sound to a desired level if the level of loudness of the sensed audible sound is unacceptable.

13. The method of claim 12, further including the step of applying a D.C. voltage to stiffen said piezoelectric element when the handset is operated in an inaudible vibration mode.

14. The method of claim 12, further including the step of causing the piezoelectric element to vibrate out of phase with audible sound produced in a selected mode and thereby sonically cancel the audible sound in this mode.

15. The method of claim 12, wherein said step of adjusting includes reducing the loudness of the audible sound to an acceptable level when the handset is coupled to the ear.

16. The method of claim 12, wherein said step of adjusting includes reducing the loudness of the audible sound to 120 dbspl peak if the level of loudness of the sensed audible sound exceeds 120 dbspl peak.

17. A wireless handset, comprising:
means for receiving transmitted radio signals;
means for producing vibrations corresponding to the received radio signals and to signal a sonic or silent alarm;
means for generating electrical signals corresponding to the loudness of said vibrations; and
means for analyzing said electrical signals and adjusting the loudness of said vibrations to a desired level.

18. The handset of claim 17, wherein said means for producing includes an actuator.

19. The handset of claim 17, wherein said means for generating includes a piezoelectric disk.

20. The handset of claim 17, wherein said means for generating includes a piezoelectric disk and said means for producing includes an actuator and a diaphragm sonically coupled to said disk.
